(19) United States
(12) Patent Application Publication
(10) Pub. No.: US 2026/0130360 A1
(43) Pub. Date: May 14, 2026

(54) FOLDABLE SADDLE HUNTING PLATFORM

(71) Applicant: AVID STRATEGIC LLC, Frankenmuth, MI (US)

(72) Inventors: Scott LEE, Frankenmuth, MI (US); Matthew R. Voorhees, Rome, NY (US)

(21) Appl. No.: 19/442,414

(22) Filed: Jan. 7, 2026

Related U.S. Application Data
(63) Continuation-in-part of application No. 19/316,300, filed on Sep. 2, 2025, now abandoned.
(60) Provisional application No. 63/690,001, filed on Sep. 3, 2024.

(51) Int. Cl. A01M 31/02

(52) U.S. Cl. CPC A01M 31/02

(57) ABSTRACT

An apparatus for saddle hunting includes a user-supporting platform having a main body with an upper support surface and a recess extending into the main body below the upper support surface. A central post has a lower end hingedly coupled to the platform and a standoff fixed to an upper region of the post and immovable relative thereto. The post is selectively movable between a deployed position, in which the post projects generally upwardly from the platform to support the apparatus against a tree, and a stowed position, in which the post and the standoff are received at least partly into the recess below the level of the upper support surface to form a compact, low-profile configuration for transport and storage.

### CROSS-REFERENCE TO RELATED APPLICATIONS

This U.S. CIP Patent Application claims priority to U.S. Utility patent application Ser. No. 19/316,300, filed Sep. 2, 2025, and U.S. Provisional Patent Application Ser. No. 63/690,001, filed Sep. 3, 2024, the entire contents of both which are incorporated herein by reference.

### BACKGROUND OF THE INVENTION

### 1. Technical Field

The present disclosure relates to foldable tree platforms designed for saddle hunting.

### 2. Related Art

Portable tree-climbing platforms are designed for a specialized form of elevated hunting known as saddle hunting in which a user is suspended in a saddle from a tree via a tether line and uses the platform as a stable foothold for comfort and agility.

The field of saddle hunting has long faced challenges related to the portability, ease of use, and functionality of tree platforms. Existing solutions are often plagued by significant limitations, including excessive weight, bulkiness, and complex designs that require multiple components to be assembled or adjusted and which do not collapse to a compact form making them difficult to transport and pack, particularly in remote or densely wooded areas where bulky or protruding elements can snag on clothing, branches, or underbrush, causing inconvenience, noise, and potential disruption to the hunting experience. The lack of a streamlined, lightweight, and easily deployable platform has left a gap in the market for hunters seeking a more efficient and practical solution.

### BRIEF SUMMARY OF THE DISCLOSURE

The present disclosure addresses these shortcomings by introducing a foldable tree platform apparatus specifically designed for saddle hunting. The described platform incorporates a user-supporting main body with an upper support surface and a recessed area that accommodates a central post and standoff when in a stowed position. This design enables the platform to fold into a compact, low-profile form, facilitating ease of carrying, storage, and transportation without the risk of snagging or generating noise. The central post, hingedly coupled to the platform, is selectively movable between a deployed position for secure tree engagement and a stowed position where the post nests at least partly within the recess, ensuring a streamlined and unobtrusive profile.

The described apparatus further enhances functionality by incorporating a fixed standoff with tree-engaging teeth and a foot pad. The standoff moves with the post and is received at least partly into the recess when the post is stowed. The foot pad may advantageously be fully received into the recess. The compact and lightweight design, combined with the intuitive folding mechanism, allows for quick, silent setup and takedown, addressing the needs of mobility, ease of use, and stealth in saddle hunting. This approach provides a high-functioning yet minimalist solution that offers advancements over existing designs.

### THE DRAWINGS

These and other features and advantages will be more readily appreciated when considered in view of the detailed description and drawings, in which:

FIG. 1 is perspective view of an embodiment of the platform in a deployed position;

FIG. 2 is another perspective view of the platform in the deployed position;

FIG. 3 is another perspective view of the platform in the deployed position;

FIG. 4 is a side elevation view of the platform in the deployed position;

FIG. 5 is a top plan view of the platform in the deployed position;

FIG. 6 is a perspective view of the platform in a stowed position;

FIG. 7 is another perspective view of the platform in the stowed position;

FIG. 8 is a side elevation view of the platform in the stowed position; and

FIG. 9 is a top plan view of the platform in the stowed position.

### DETAILED DESCRIPTION OF EMBODIMENTS OF THE INVENTION

The following detailed description provides illustrative embodiments of the disclosed subject matter and is intended to enable those skilled in the art to make and use the disclosed subject matter. It is understood that the embodiments described herein are provided for illustration purposes and are not limiting, and that the scope of the disclosed subject matter is defined by the claims. The disclosed subject matter generally pertains to foldable tree platforms designed for saddle hunting, offering lightweight, compact, and streamlined solutions for hunters seeking mobility, ease of use, and silent operation in remote or wooded areas.

For clarity and conciseness, certain well-known features, components, or methods may not be described in detail, as they are readily understood by those skilled in the art. Additionally, various modifications, substitutions, or rearrangements of the described components and configurations may be made without departing from the spirit and scope of the described subject matter. The examples provided herein are intended to illustrate the principles of the described subject matter and are not to be construed as limiting the scope to the specific embodiments disclosed. The drawings scaled and show relative dimensions, angles, positions and lengths of the parts and features in both a deployed position as would be used while hunting and a stowed position representing the compact form of the apparatus when being transported or stored.

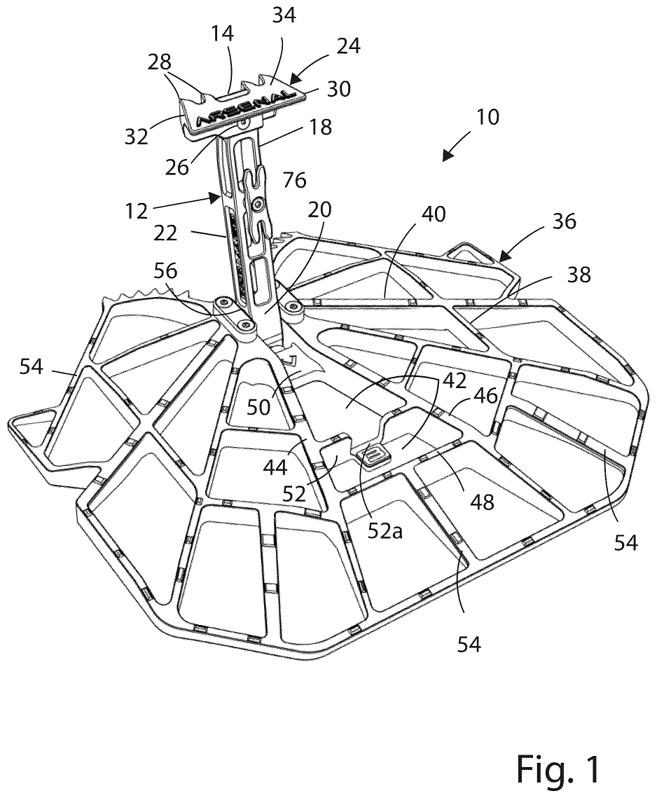

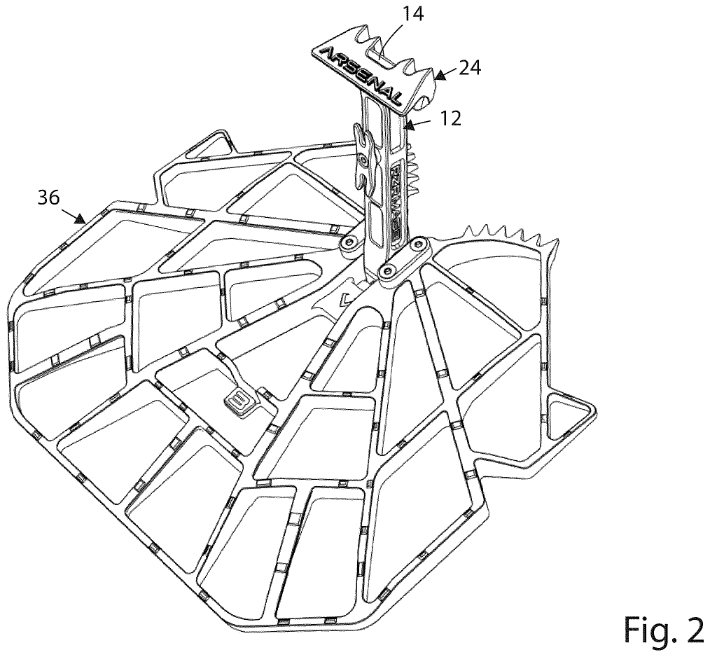

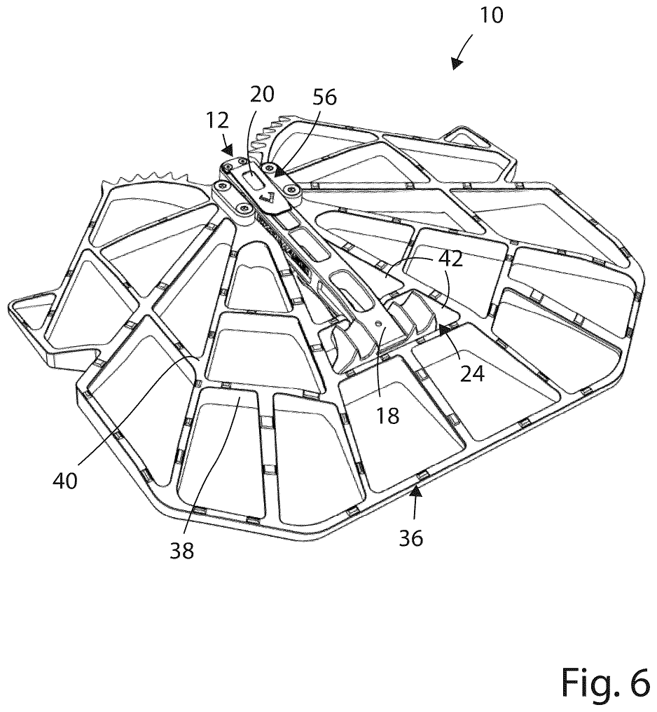

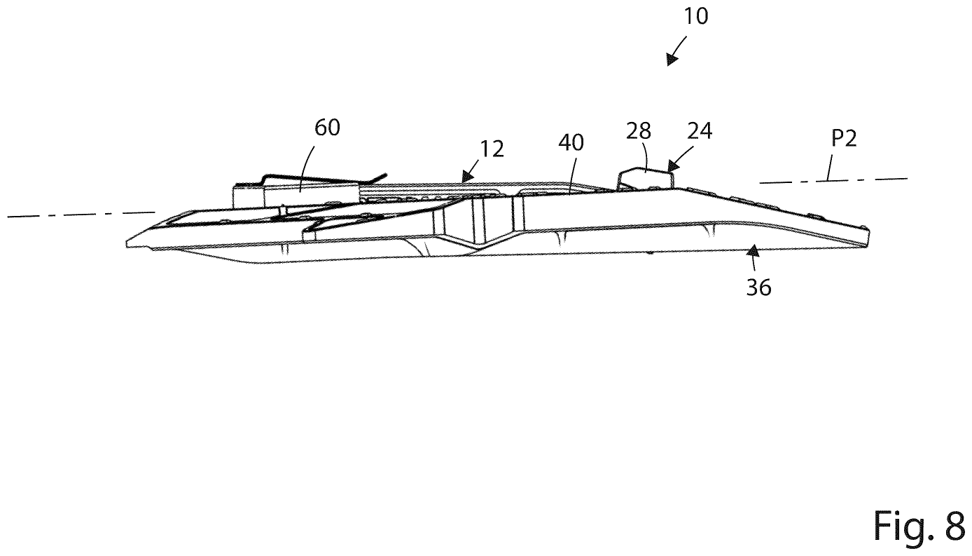

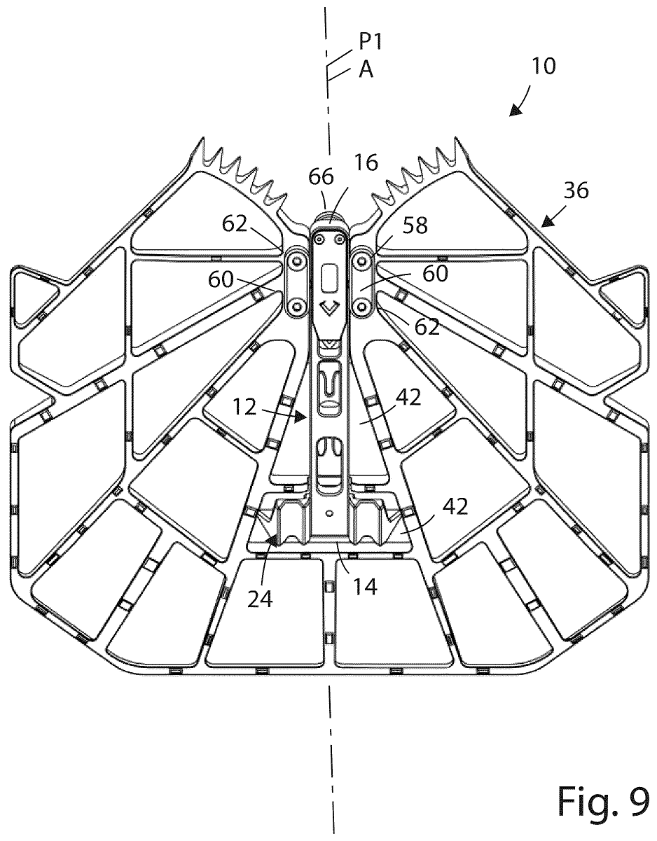

A platform apparatus 10 according to one embodiment comprises a portable, collapsible structure configured for saddle hunting. The apparatus 10 is adapted to be mounted to a tree trunk and to provide a stable foothold for a hunter who is suspended in a saddle from the tree by a tether line positioned above the platform 10. The apparatus 10 is selectively movable between a deployed position, as shown in FIGS. 1-5, in which the apparatus is arranged for mounting and use in the tree, and a stowed position, as shown in FIGS. 6-9, in which the apparatus is folded into a compact, low-profile form for transport and storage.

The apparatus 10 includes a central post 12. The central post 12 comprises an elongate, rigid support member extending longitudinally between an upper end 14 and a lower end 16 and, in use, is positioned along the tree trunk. The post 12 functions as the primary vertical backbone of the apparatus 10. The post 12 may be formed from materials commonly used for tree platform posts, such as metals, reinforced plastics or composites, but is preferably manufactured as a single piece of structural aluminum that is forged and/or machined. The post 12 includes an upper region 18 adjacent the upper end 14, a lower region 20 adjacent a lower end 16, and a central main body region 22 between the upper and lower regions 18, 20.

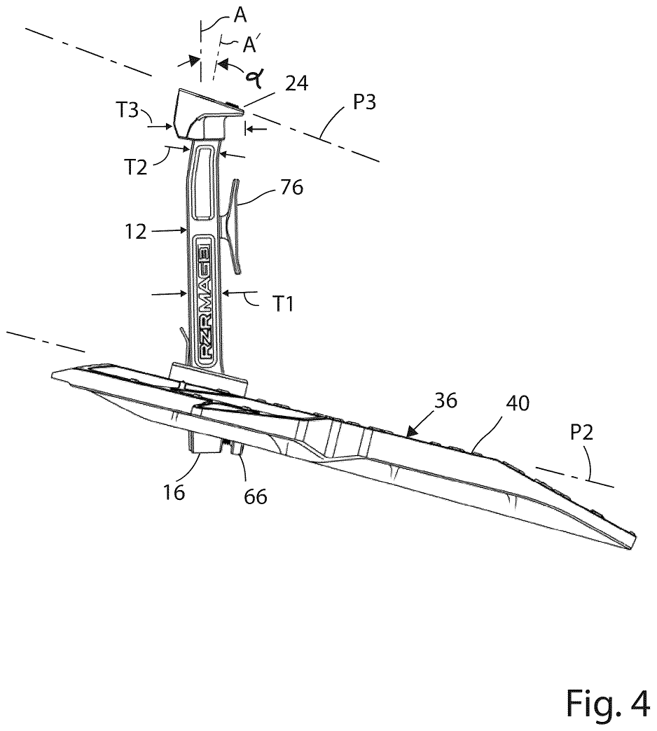

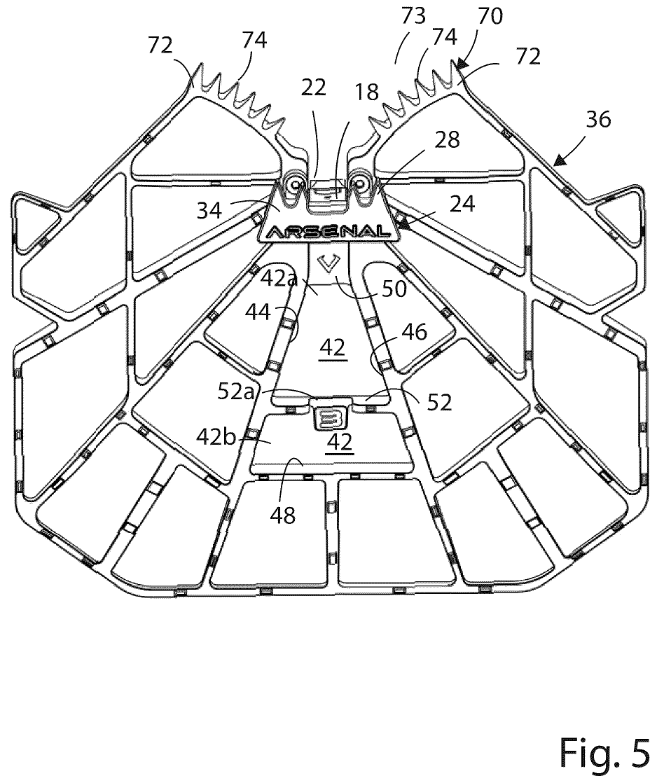

An upper standoff 24 is fixed to the upper region 18 of the post 12 and engages the tree to provide stability and support to the post 12 in use. The upper standoff 24 may be formed integrally with the central post 12 or fabricated as a separate component and thereafter fixed immovably to the post 12. In the illustrated embodiment, the upper standoff 24 is made of structural aluminum forged and/or machined as one piece and secured rigidly to the post 12 by at least one fastener 26. The upper standoff 24 may include a U-shaped mounting collar that fits about the upper region 18 of the post 12. The upper standoff 24 includes rearwardly projecting tree-engaging teeth 28 and a foot pad portion 36 projecting forwardly and laterally of the post 12. An upper surface 32 of the standoff 24 defines, at least in part, a generally planar upper step surface 34 at the upper distal end of the apparatus 10 when the post 12 is in the deployed position. Preferably, the step surface 34 is formed by the upper surface 38 in combination with upper surfaces of the teeth 28 and may further include the upper distal end 14 of the post 12 that all may lie in a common upper step surface plane P3. The upper step surface 34 is preferably angled forwardly relative to a longitudinal axis A of the central post 12, forming an acute angle between the plane of the upper step surface 34 and the longitudinal axis of the central post 12. When the post 12 is upright, the “forwardly angled” plane corresponds to a downward tilt relative to the central longitudinal axis. As shown in FIG. 4, the upper region 18 of the post 12 is preferably tilted forward relative to the longitudinal primary axis A of the post 12. This tilt defines a secondary axis A′ that forms an acute forward angle α with the primary axis A. The upper region 18 is preferably narrower in front-to-back thickness T2 than the front-to-back thickness T1 of the main body region 22 of the post 12. The standoff has a front-to-back thickness T3 that is less than twice the front-to-back thickness T1 of the main body region 22 of the post 12. The terms “front,” “back,” “forward,” “rearward,” “left,” “right,” “upper,” “lower,” “top,” and “bottom” are directional or orientational descriptors used with reference to the apparatus 10 in its deployed, open position, as viewed by a user facing the apparatus as it would be mounted on a tree. The back side surface of the upper region 18 may be tapered or curved. The teeth 28 of the upper standoff 24 have roots that commence inward of at least the back side surface of the main body region 22 of the post 12 and more preferably the back side surface of the upper region 18 of the post 12 as well, as best illustrated in the plan view of FIG. 5. The peaks of the teeth 28 project beyond the back of the post 12. Distal contact surfaces of the tree-engaging teeth 28 are angled forwardly relative to the post's longitudinal axis in the deployed position.

The apparatus 10 further includes a platform 36 hingedly coupled to the lower region 20 of the central post 12. The platform 36 has a main body portion 38 with an upper support surface 40 that provides a primary surface for the hunter to stand on or leverage against with one or both feet during use. The upper support surface 40 may be generally flat, but may also include protrusions, chamfers, cutouts, and angled features for ergonomics, weight reduction, and aesthetics. The upper support surface 40 defines a reference plane P2 into and below which the central post 12 and upper standoff 24 may extend when in a stowed position, as described further below, it being understood that the term “plane” refers to the general level of the surface 40 and does not limit the surface 40 to being purely flat in a geometric sense.

The platform 36 includes at least one recess or depression 42 extending into the main body portion 38 from the upper support surface 40. The recess 42 has laterally spaced left and right side walls 44, 46 and at least a front wall 48 that bound the recess 42 and comprise internal structure of the platform 36 inbound of the platform edges. The back of the cavity may be open to the back edge of the platform 36 or may be closed by a back wall and may depend in part in the manner in which the post 12 is hinged to the platform 36. The recess 42 comprises a cavity or pocket that extends below the upper support surface 40 and is shaped and positioned relative to the central post 12 and upper standoff 24 to receive both the post 12 and fixed upper standoff 32 at least partly into the recess 42 when stowed, so that the post 12 and standoff 32 nest with the recess 42 of the platform 36 when stowed as described further below. The platform 36 is preferably metal and more preferably machined from 7075 billet aluminum. In certain embodiments, the platform 36 has an open, grate-like structure comprising a continuous band of metal around the perimeter and a web of intersecting ribs providing a rigid yet lightweight support structure. The side 44, 46 and front 48 walls of the recess 42 may be formed by select ones of the ribs. As can be seen in FIGS. 1 and 5, additional cross ribs 50, 52 may extend laterally across the recess 42 between the side walls 44, 46 and may have notches 52a as in cross rib 52 or have a reduced thickness as in cross rib 50 to accommodate receipt of the post 12 and/or standoff 32 into the recess 42. The recess 42 may comprise a narrow width portion 42a near the back of the recess 42 adjacent the hinged connection with the post 12 and may have a wider width portion 42b near the front of the recess 42 to accommodate the standoff 32. The recess 42 lies along a plane P1 bisecting the platform 36 front to back and preferably the recess 42 and platform 36 have mirror symmetry across the bisecting plane. The platform 36 may further include a tapered rim or border portion 54 to provide an ergonomically friendly foothold region that conforms more closely to the angle of the hunter's feet when tethered from the tree above the platform 36. The tapered rim portion 54 is an extension of the upper support surface 40 and is angled or tapered downwardly toward the bottom side of the platform 36. The tapered rim portion extends across at least a front edge region of the platform 36 and may extend along the back edge region, and may additionally extend along all or part of the left and right side edge regions.

The platform 39 and the lower region 20 of the post 12 are connected by a hinge joint 56. The hinge joint 56 includes a hinge pin 58 extending between and interconnecting the lower region 20 of the post 12 and the platform 36. The hinge pin 58 is preferably fixed against rotation to one of the platform 36 or the post 12, with the other component rotating relative to the hinge pin 58. In the illustrated embodiment, the hinge pin 58 is fixed to the platform 36 and the post 12 rotates relative to the hinge pin 58. More specifically, the opposite end portions of the hinge pin 58 are captured by the platform 36, and the pin extends through an axially aligned passage in the lower region 20 of the post 12 about which the post 12 pivots relative to the hinge pin 58 and the platform 36. The platform 36 may include a pair of mounting hinge blocks or bosses 60 projecting upwardly from the upper surface 40 of the platform 36. The blocks 60 are disposed on opposite sides of the recess 42 in line with the side walls 44, 46, may be separately formed, and may be secured to the platform 36 by fasteners 62. The blocks 60 and platform 36 have mating interfaces configured to receive the opposite ends of the hinge pin 58 therebetween and, when tightened by the fasteners 62, secure the hinge pin 58 against lateral and rotational movement. The passage through the lower region 20 of the post 12 receiving the middle portion of the hinge pin 58 supports the post 12 for rotational movement relative to the platform 36. The side walls 44, 46 and inward faces of the blocks 60 are closely gapped with respect to the left and right side faces of the lower region 20 of the post 12 to provide lateral support to the platform 36 against the post 12 in the deployed position. When the post 12 is in the stowed position, a portion of the lower region 20 of the post 12 extends below the upper support surface 40 of the platform 36 and another portion extends above the upper support surface 40 but not beyond the level of the mounting blocks 60.

The post 12 may further include one or more friction adjustment screws operative to adjustably increase or decrease the frictional resistance of the post 12 to rotation relative to the platform 36. The adjustment screws are preferably received in threaded cross-bores in the lower region 20 of the post 12 that intersect the cross-bore receiving the hinge pin 58. The adjustment screws may include frictional tips made of a tough material such as nylon that can be advanced into and retracted out of frictional engagement with the hinge pin 58 at one or more locations. Tightening an adjustment screw urges its frictional tip against the hinge pin 58 to create drag to rotation of the post 12 about the pin 58. The user can select the desired degree of frictional resistance by controlling how far the adjustment screw is turned in against the hinge pin 58. Should a frictional tip wear over time, it can be quickly replaced by removing the spent adjustment screw and installing a new one. The friction adjustment screws may be located beneath a belt or MOLLE web clip 64 secured to the backside of the lower region 20 of the central post 12.

The hinged post 12 is aligned with the bisecting plane of the recess 42 and the platform 36. In the deployed position, as illustrated in FIGS. 1-5, the post 12 extends generally upright from the platform 36 for placement against the tree trunk. The angle of the post 12 relative to the platform 36 in the deployed position is adjustable by an adjustment device comprising a thumb screw 66 located on the lower region 20 of the post 12 below the hinge pin 58 and positioned to confront a corresponding stop surface 68 of the platform 36. Threading the thumb screw 66 inward increases the obtuse angle between the front face of the post 12 and the upper support surface 40 by tilting the post further rearward toward the tree, whereas threading the thumb screw outward advances the screw head toward the stop surface, decreasing the angle between the post 12 and the platform 36. The stop surface 68 may be provided on the back side of the cross rib 50 of the recess 42.

The platform 36 includes a lower standoff 70 at its back edge. The standoff 70 comprises a pair of opposing jaws 72 disposed on left and right sides of the central post 12 and extending laterally and rearwardly to form a generally V-shaped cradle 73 configured to engage the tree trunk in use. The post 12 is positioned between and forward of the jaws 72. The jaws 72 include a plurality of tree-gripping teeth 74 operative to bite into the tree trunk under load, thereby enhancing stability of the apparatus during use.

The central region 22 of the post 12 includes a mounting lug 76, which may be a button or cleat, positioned closer to the upper standoff 24 than to the platform 36. The lug 76 is configured to receive one end of a mounting rope or strap that is wrapped around the tree trunk and then reengaged with the lug 76 to releasably secure the apparatus 10 tightly against the tree. In use, the post 12 is first moved to its deployed position and placed against the tree at the desired height. While holding the post 12 to the trunk, the rope or strap is wrapped around the tree and secured to the lug 76. The platform 36 is then pivoted downward relative to the post 12, causing the jaws 22 to cradle the tree and cam the platform 36 outward against the rope tension. Continued rotation of the platform 36 to the fully deployed position drives the teeth 24 into the trunk, thereby stabilizing the apparatus 10 on the tree.

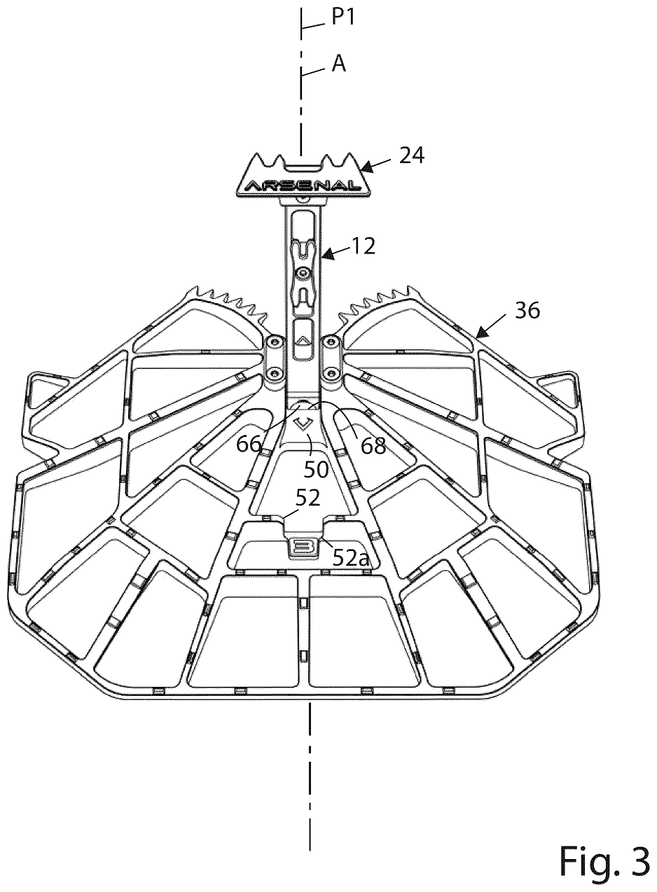

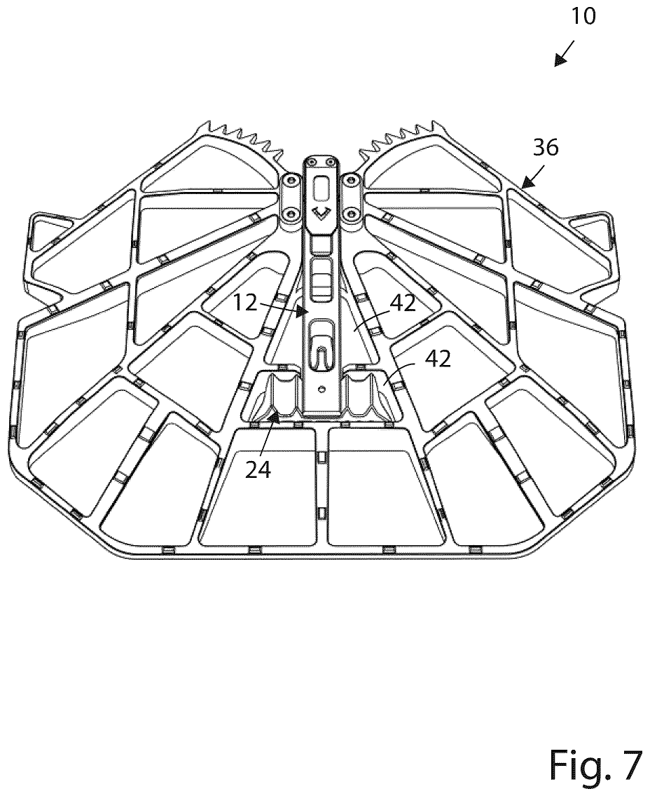

When the platform 36 is not in use and is to be stored or otherwise transported, the user rotates the post 12 toward the platform 36 until the post 12 and the upper standoff 24 are received into the recess 42 in a stowed position, as illustrated in FIGS. 6-9. FIGS. 1 and 6 show one set of complementary views of the apparatus 10 in the deployed and stowed conditions, respectively. FIGS. 3 and 7 are another set of complementary views of the apparatus 10 in deployed and use positions, as are FIGS. 4 and 8 and FIGS. 5 and 9. In the stowed condition, at least a portion of the post 12 and the standoff 24 is disposed below the level or plane of the upper support surface 40 of the platform 36. Preferably, approximately half of the length of the post 12 is received within the recess 42 along the full length of the post. At least part, and more preferably all, of the foot pad portion 30 of the upper standoff 24 is received in the recess 42 below the level of the upper support surface 40. The teeth 28 of the upper standoff 24 may project above the upper support surface 40 when the post 12 is stowed. The clip 64 allows the user to hook the collapsed platform apparatus 10 onto a belt or MOLLE webbing on a backpack or similar gear. The compact, low-profile form also enables the platform 10 to be slid directly into a backpack or tote for transport.

When stowed, the forwardly angled back surface of the post 12 lies in a plane that is an extension of the downwardly angled front edge portion of the tapered border 54 of the platform 36, providing a smooth and aesthetically pleasing visual transition of the components.

The simple construction of the platform apparatus 10, its compact configuration when stowed, and its ease of redeployment when ready for use address previously unmet needs in the industry.

Obviously, many modifications and variations of the present invention are possible in light of the above teachings. It is, therefore, to be understood that the invention may be practiced otherwise than as specifically described while still being within the scope of the invention.

What is claimed is:

1. A foldable tree platform apparatus for saddle hunting, comprising:
a user-supporting platform having a main body with an upper support surface, the platform including a recess that extends into the main body below the upper support surface;
a central post having a lower end hingedly coupled to the platform and a standoff fixed to an upper region of the post and immovable relative to the post; wherein
the post is selectively movable between a deployed position in which the post projects generally upwardly from the platform to support the apparatus against a tree; and a stowed position in which the post and the standoff are received at least partly into the recess below the level of the upper support surface.

2. The apparatus of claim 1, wherein, the post has a main body with a longitudinal central axis and wherein an upper portion of the post is angled forwardly relative to the central axis.

3. The apparatus of claim 1, wherein the standoff includes tree-engaging teeth portions projecting rearwardly of the post and a foot pad portion projecting forwardly and laterally of the post.

4. The apparatus of claim 3, wherein the foot pad is received fully into the recess when the post is in the stowed condition, such that the foot-engaging post is below the plane of the upper surface when stowed.

5. The apparatus of claim 4, wherein the tree-engaging teeth extend at least partly above the plane of the upper surface when in the stowed position.

6. The apparatus of claim 3, wherein the foot pad has an upper surface defining at least in part a generally planar step surface at an upper distal end of the apparatus when the post is in the deployed position.

7. The apparatus of claim 6, wherein, the step surface is tilted downwardly relative to the central axis when the post is in the deployed position.

8. The apparatus of claim 6, wherein an upper surface of the teeth and upper end of the post lie in a common plane with the upper surface of the foot pad and form an extension of step surface.

9. The apparatus of claim 1, wherein the tree-engaging teeth have distal contact surfaces that are angled forwardly relative to the longitudinal axis of the post when in the deployed position.

10. The apparatus of claim 3, wherein the tree-engaging teeth have inner most roots that are disposed forwardly of a rear face of the main body portion of the post.

11. The apparatus of claim 2, wherein the main body of the post has a front-to-back thickness and wherein the standoff has a front-to-back thickness and wherein the thickness of the standoff is less than twice the thickness of the main body of the post.

12. The apparatus of claim 1, wherein the standoff is forged as one piece including a U-shaped mounting collar portion that fits about the upper end section of the post, a foot pad portion projecting laterally and forwardly of the mounting collar portion and tree-engaging teeth projecting rearwardly of the foot pad portion, and wherein the foot pad portion, the tree-engaging teeth and an upper end face of the post define a generally planar step surface at the distal upper end of the apparatus when the post is in the deployed position.

13. The apparatus of claim 2, wherein the main body of the post has a thickness measured from front-to-back of the main body and wherein the upper portion of the post has a thickness measured from front-to-back of the upper portion, and wherein the thickness of the upper portion is less than the thickness of the main body.

14. The apparatus of claim 1, wherein the post has a main body portion with a central longitudinal axis and wherein an upper portion of the post has a back surface thereof that is angled forwardly relative to the central axis when the post is in the deployed position, and wherein a front edge portion of the platform is angled downwardly relative to the plane of the upper surface, and wherein the forwardly angled back surface of the upper portion of the post lies in a plane of the downwardly angled front edge portion of the platform when the post is in the stowed position.

15. The apparatus of claim 1, wherein the recess is bordered by laterally spaced side walls of the platform extending below the upper support surface and further bordered by a front wall of the platform extending below the upper support surface.

16. The apparatus of claim 1, wherein the platform includes raised mounting bosses disposed on the upper support surface on opposite sides of the recess, and wherein, when the post is in the stowed position, a portion of the lower region of the post extends below the upper support surface and another portion extends above the upper support surface but does not extend beyond the height of the mounting bosses.
